(19) United States
(12) Patent Application Publication
(10) Pub. No.: US 2019/0272676 A1
(43) Pub. Date: Sep. 5, 2019

(54) LOCAL POSITIONING SYSTEM FOR AUGMENTED REALITY APPLICATIONS

(71) Applicant: F3 & Associates, Benicia, CA (US)

(72) Inventors: Sean Finn, Benicia, CA (US); Eric Horbatiuk, Oakland, CA (US); Michael Ferreira, Benicia, CA (US)

(73) Assignee: F3 & Associates, Benicia, CA (US)

(21) Appl. No.: 16/416,905

(22) Filed: May 20, 2019

Related U.S. Application Data
(63) Continuation of application No. 15/448,434, filed on Mar. 2, 2017.
(60) Provisional application No. 62/304,514, filed on Mar. 7, 2016.

(51) Int. Cl. G06T 19/00; G06T 7/73; G06F 17/50

(52) U.S. Cl. CPC G06T 19/006; G06T 7/73; G06F 17/5004; G06T 2210/04; G06T 2207/30244; G06T 2207/30204; G06F 17/5009

(57) ABSTRACT

Embodiments of the invention are directed to methods and systems for using local positioning beacons to create precise augmented reality images. Embodiments of the invention are also directed to providing different types of augmented reality images to different types of devices and/or individuals.

### CROSS-REFERENCES TO RELATED APPLICATIONS

This application is a non-provisional application of and claims the benefit of the filing date of U.S. Provisional Application No. 62/304,514, filed on Mar. 7, 2016, which is herein incorporated by reference in its entirety for all purposes.

### BACKGROUND

In the fields of architecture, design, facility management, and construction, ideas and plans need to be communicated clearly to coordinate successfully with all parties involved in a project. When a project involves modifying an existing structure or constructing a new structure, a new design for the structure can be generated in the form of a virtual three dimensional (“3D”) model using computer modeling software. The virtual 3D model can be viewed on a computer screen so that all of the involved parties can discuss their ideas. However, the 3D modeling software is not easy to use for people unless they are trained to use the software. Therefore, all the parties may not be able to fully participate in the discussion, while manipulating the 3D digital model shown on the computer screen. Furthermore, while virtual 3D models can help a person visualize the project on a computer screen, it is not easy for the human brain to translate the information shown on the computer screen and visualize it on-site in the real world. Thus, there is a need to improve the presentation and planning of future projects in the fields of architecture, design, facility management, and construction.

Embodiments of the invention address these and other problems individually and collectively.

### SUMMARY

Embodiments of the invention provide a 3D digital model including a project site that is tied to a real-world coordinate system. Information about a future physical element, a change to an existing structure, or any other suitable project can be inserted into the 3D digital model and assigned real-world coordinates. Embodiments further provide a positioning system that includes local beacon devices at a project site. The beacon devices are placed at locations with precise, surveyed coordinates. The beacon devices communicate with a mobile device, such that an accurate position of the mobile device can be determined. The mobile device can also receive information about the project site, including a 3D digital model including a future physical element associated with specific real-world coordinates. A user may move around the project site, observing the project site through a display screen of the mobile device. Using the mobile device location, the 3D digital model, and the real-world coordinates for the future physical element, the mobile device can create an augmented reality image where the 3D digital model including the future physical element is overlaid onto a real-world image. The future physical element can be shown in its precise real-world coordinates. In some embodiments, the 3D digital model can also be displayed, such that the future physical element is displayed by the mobile device within and along with a 3D digital model of existing physical elements.

One embodiment of the invention is directed to a method comprising surveying a real environment including existing physical elements. One or more targets are positioned at one or more control points in the real environment so that coordinates of the one or more control points in relation to a real-world coordinate system can be determined. The method further comprises importing the coordinates of the surveyed control into a 3D modeling computer, generating a 3D digital model including the existing physical elements in relation to the real-world coordinate system, generating a 3D digital model including a future physical element, and incorporating the 3D digital model including the future physical element at a location within or proximate the 3D digital model including the existing physical elements, such that the future physical element is associated with a future physical element location in the real-world coordinate system. The method also comprises storing a data file comprising the 3D digital model including the future physical element and future physical element location data, placing a plurality of beacon devices at a plurality of beacon device locations in the real environment, and surveying the plurality of beacon devices. A target is positioned at each beacon device such that coordinates of the plurality of beacon devices in relation to the real-world coordinate system can be determined. The method further comprises storing the coordinates of the plurality of beacon devices in a database. A mobile device position of a mobile device is determined based on communications between the plurality of beacon devices and the mobile device. Also, when the determined mobile device position is within a predetermined region associated with the future physical element, an augmented reality image based on the data file is displayed at the mobile device. The augmented reality image comprises a real view of the real environment seen through the camera of the mobile device in real-time overlaid with the 3D digital model including the future physical element at the future physical element location.

Another embodiment of the invention is directed to a server computer configured to perform the above-described method.

Another embodiment of the invention is directed to a method comprising receiving, by a mobile device, a plurality of signals from a plurality of beacon devices, and determining a position of the mobile device in a real-world coordinate system based on the plurality of received signals. The method also includes capturing an image of a real environment. The image is captured using a camera of the mobile device. The image includes one or more existing physical elements. The method also comprises providing an augmented reality image on a display screen of the mobile device. The augmented reality image includes a real view of the real environment seen through the camera of the mobile device in real-time overlaid with a 3D digital model including a future physical element at a future physical element location in the real-world coordinate system.

Another embodiment of the invention is directed to a mobile device configured to perform the above-described method.

Another embodiment of the invention is directed to a method comprising surveying a real environment including existing physical elements. One or more targets are positioned at one or more control points in the real environment so that coordinates of the one or more control points in relation to a real-world coordinate system can be determined. The method further comprises importing the coordinates of the surveyed control into a 3D modeling computer, generating a 3D digital model including the existing physical elements in relation to the real-world coordinate system, generating a first 3D digital model including a first future physical element, and incorporating the first 3D digital model including the first future physical element at a first location within or proximate the 3D digital model including the existing physical elements, such that the first future physical element is associated with a first future physical element location in the real-world coordinate system. The method further includes associating the first future physical element with a first category, and storing a first data file comprising the first 3D digital model including the first future physical element, first future physical element location data, and a first category indicator. The method further comprises generating a second 3D digital model including a second future physical element, and incorporating the second 3D digital model including the second future physical element at a second location within or proximate the 3D digital model including the existing physical elements, such that the second future physical element is associated with a second future physical element location in the real-world coordinate system. The method further includes associating the second future physical element with a second category, and storing a second data file comprising the second 3D digital model including the second future physical element, second future physical element location data, and a second category indicator. A first mobile device position of a first mobile device associated with the first category is determined based on communications between a plurality of beacon devices and the first mobile device. Also, when the determined first mobile device position is within a predetermined region associated with the first future physical element, an augmented reality image based on the first data file is displayed at the first mobile device. The augmented reality image comprises a real view of the real environment seen through the camera of the first mobile device in real-time overlaid with the first 3D digital model including the first future physical element at the first future physical element location. A second mobile device position of a second mobile device associated with the second category is determined based on communications between a plurality of beacon devices and the second mobile device. Also, when the determined second mobile device position is within a predetermined region associated with the second future physical element, an augmented reality image based on the second data file is displayed at the second mobile device. The augmented reality image comprises a real view of the real environment seen through the camera of the second mobile device in real-time overlaid with the second 3D digital model including the second future physical element at the second future physical element location.

Another embodiment of the invention is directed to a server computer configured to perform the above-described method.

Another embodiment of the invention is directed to a method comprising capturing an image of a real environment. The image includes one or more existing physical elements. The image is captured using a camera of a first mobile device that is associated with a first category. The method further includes retrieving a first data file comprising a first 3D digital model including a first future physical element and first future physical element location data that identifies a first location in a real-world coordinate system. The first data file is associated with the first category. The method also comprises providing a first augmented reality image on a display screen of the mobile device. The first augmented reality image includes a real view of the real environment seen through the camera of the first mobile device in real-time overlaid with the first 3D digital model including the first future physical element at the first future physical element location in the real-world coordinate system. The method further includes capturing an image of the real environment using a camera of a second mobile device that is associated with a second category. The image includes one or more existing physical elements. The method further includes retrieving a second data file comprising a second 3D digital model including a second future physical element and second future physical element location data that identifies a second location in a real-world coordinate system. The second data file is associated with the second category. The method also comprises providing a second augmented reality image on a display screen of the mobile device. The second augmented reality image includes a real view of the real environment seen through the camera of the second mobile device in real-time overlaid with the second 3D digital model including the second future physical element at the second future physical element location in the real-world coordinate system.

Another embodiment of the invention is directed to a first mobile device and a second mobile device configured to perform the above-described method.

Further details regarding embodiments of the invention can be found in the Detailed Description and the Figures.

### BRIEF DESCRIPTION OF THE DRAWINGS

FIG. 1 shows a block diagram of a system, according to an embodiment of the invention.

FIG. 2 shows an example of a beacon devices distributed in a real environment, according to an embodiment of the present invention.

FIG. 3 shows an example of a beacon device, according to an embodiment of the present invention.

FIG. 4 shows an example of an augmented reality image, according to an embodiment of the present invention.

FIGS. 5A-5C show a flow diagram illustrating a method for determining a precise location of a mobile device in order to provide precise augmented reality images, according to an embodiment of the present invention.

FIG. 6 shows a flow diagram illustrating a method for viewing an augmented reality image in real-time, according to an embodiment of the present invention.

### DETAILED DESCRIPTION

Prior to discussing specific embodiments of the invention, some terms may be described in detail.

As used herein, a “mobile device” may comprise any suitable electronic device that may be transported and operated by a user. A mobile device may be able to display images. For example, a mobile device can include a camera and a display screen. A mobile device may also include a computer readable memory and software modules, such as an augmented reality application. Further, a mobile device can include wireless communication sensors. In some embodiments, a mobile device can include one or more additional sensors and instruments, such as a GPS device, a gyroscope, a compass, an accelerometer, a barometer, a range measurement tool, and/or any other suitable sensor.

In some embodiments, a mobile device may also provide remote communication capabilities to a network. Examples of remote communication capabilities include using a mobile phone (wireless) network, wireless data network (e.g. 3G, 4G or similar networks), Wi-Fi, Wi-Max, or any other communication medium that may provide access to a network such as the Internet or a private network. Examples of mobile devices include mobile phones (e.g. cellular phones), PDAs, tablet computers, net books, laptop computers, hand-held specialized readers, etc. Further examples of mobile devices include wearable devices, such as smart glasses, etc. A mobile device may comprise any suitable hardware and software for performing such functions, and may also include multiple devices or components (e.g. when a device has remote access to a network by tethering to another device—i.e. using the other device as a modem—both devices taken together may be considered a single mobile device).

As used herein, a “physical element” may be a tangible feature located in a certain area. Examples of a physical element include structures such a building, a pipe, a wire, a wall, a floor, a ceiling, a sidewalk, a parking lot, a window, a desk, a door, or any other suitable item. Physical elements can also include dimensions and other aspects of a space, such as an open space of a certain volume, area, or shape, a quality or type of material, or any other suitable factor that can be used to describe a region.

As used herein, a “project site” may be a place where work is being done. Examples of a project site include a construction site, a home being renovated, or any other place where construction, structural maintenance, or physical modifications can take place. In some embodiments, a project site can be defined by one or more physical elements, such as a building with certain features, a boundary space of a certain size, etc. A project site may only include undeveloped earth and boundary lines for a construction project that has yet to begin. A number of project types can take place at a project site, such as construction projects, plumbing projects, electrical projects, redesigning projects, maintenance projects, cleaning projects, painting projects, planting projects, and any other suitable type of project.

The term “server computer” may include a powerful computer or cluster of computers. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

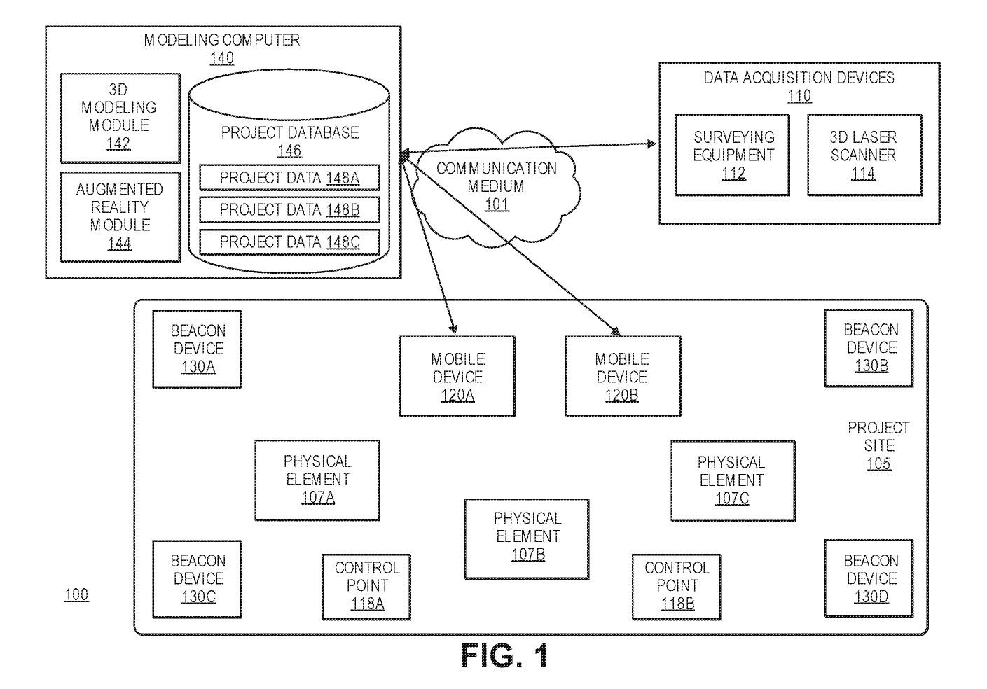

FIG. 1 shows a schematic diagram illustrating a system 100 having a number of components that integrate augmented reality (or “AR”) technology with land surveying, 3D laser scanning, and 3D modeling processes according to an embodiment of the invention. The system 100 includes a project site 105 in a real environment. The project site 105 includes physical elements 107A-C. In some embodiments, the project site 105 can be defined by the physical elements 107A-C. Additionally, beacon devices 130A-D may be present at the project site 105. The beacon devices 130A-D may be associated with surveyed coordinates and may transmit signals for triangulating a position of a mobile device within the project site 105. The system 100 also includes data acquisition devices 110, such as surveying equipment 112 and a 3D laser scanner 114, which are used to survey and laser scan the project site 105 (e.g., the physical elements 107A-C) to generate point cloud data with scan points at known coordinates. The system 100 shown in FIG. 1 also includes a modeling computer 140 which can receive the point cloud data from the data acquisition devices 110 and generate a 3D digital model of the project site 105. The modeling computer 140 can also generate a future physical element and associate a 3D digital model of the future physical element with a location in the project site 105 for augmented reality visualization. In addition, the system 100 includes mobile devices 120A and 120B, which may be used to capture an image of a physical element in the project site 105 to initiate and facilitate augmented reality visualization of a 3D digital model of a future physical element in a geometrically correct orientation with respect to a real-world coordinate system.

All the components shown in FIG. 1 (e.g., the data acquisition devices 110, the modeling computer 140, the mobile devices 120A-B, and the beacon devices 130A-D) can communicate with one another via a communication medium 101, which may be a single or multiple communication media. The communication medium 101 may include any suitable electronic data communication medium including wired and/or wireless links. The communication medium 101 may include the Internet, portions of the Internet, or direct communication links. In some embodiments, the components shown in FIG. 1 can receive data from one another by sharing a hard drive or other memory devices containing the data.

The data acquisition devices 110 may include surveying equipment 112 and a 3D laser scanner 114. The surveying equipment 112 and/or the 3D laser scanner can 114 gather data from the project site 105 (e.g., physical elements 107A-C). While the surveying equipment 112 and the 3D laser scanner 114 are shown in the same enclosure 110, they can be separate devices in separate enclosures.

The surveying equipment 112 can be used to survey the project site 105 (e.g., the physical elements 107A-C) in the real environment. Targets (for surveying measurements) can be positioned at one or more control points 118A-B within or around the project site 105. Through surveying, the coordinates of the control points 118A-B in relation to a real-world coordinate system can be determined. Examples of surveying equipment 112 include total stations, theodolites, digital levels, survey transits, or the like. The surveying equipment 112 can be used to perform horizontal and/or vertical measurements to specify locations in 3D on the earth using coordinates. The surveying equipment may typically report each surveyed target's coordinates in terms of “Northing, Easting, Elevation.”

In embodiments of the present invention, real-world coordinates of a control point 118 or any location can refer to its horizontal position on the surface of the earth and its vertical position (e.g., elevation). The horizontal position of a location can be defined by any suitable real-world coordinate system such as a global coordinate system, a national coordinate system, state coordinate system (e.g., NAD 83, NAD 88, or the like), a local plant grid system, or the like. The vertical position or an elevation of a location can be defined according to an elevation datum. An elevation datum may be based on an elevation above Mean Sea Level, a gravity based geodetic datum NAVD88, NAD 27, or the like. Any other suitable horizontal datum and elevation datum can be used to define a point or a location in space on the earth in terms of real-world coordinates.

The 3D laser scanner 114 shown in FIG. 1 captures the project site 105 with the physical elements 107A-C in the real environment in the form of points called point clouds. Any suitable 3D laser scanner can be used in embodiments of the present invention. Examples of 3D laser scanners include Leica ScanStation™ manufactured by Leica Geosystems™, Trimble FX™ or GX™ Scanner manufactured by Trimble, other 3D laser scanners from other manufacturers, such as Faro™, Riegl™, Optech™, or the like.

While not illustrated in FIG. 1, the 3D laser scanner 114 can include a number of components, such as a laser emitter and a detector. In 3D laser scanning, laser emitter can emit a laser beam, which may then be reflected off the surface of a physical structure, such as the physical elements 107A-C, in the real environment. The reflected light from the physical structure can be captured by the detector, generating a point cloud associated with the physical structure by determining phase shift or “time-of-flight.” In an embodiment, the points can be mapped out in space based on the laser's time of flight. The scanner's range finder may determine the object's distance by timing the light pulse's round-trip. This is given by the equation: d=(c*t)/2 where d is distance, c is speed of light, and t is round-trip time. Each point in the point cloud can indicate a location of a corresponding point on a surface of the physical structure.

In order to position the point clouds accurately in an environment's coordinate system and align the point clouds, targets can be used to tie the point clouds together. The targets can be placed on the control points 118A-B (e.g., used during surveying) so that points in the point cloud are assigned coordinates (horizontal and vertical coordinates). In some embodiments, targets can have crosshairs or any other suitable markings usable for surveying the targets or identifying the targets. Two to three targets may typically be necessary for each scanner setup to accurately establish the point cloud's location in the coordinate system.

Typically, multiple point clouds can be stitched together during registration. From the point clouds, 3D digital models of surveyed and scanned elements can be created accurately to within any suitable error tolerance. For example, embodiments allow the 3D digital models to be accurate within ⅛^{th} of an inch ¼ of an inch, 1 inch, 2 inches, 5 inches, 1 foot, or any other suitable error tolerance. The following description will mostly refer to achieving ⅛^{th} inch accuracy. However, embodiments allow any suitable accuracy error tolerance to be used, as different applications may call for different error tolerances.

Referring to FIG. 1, the system 100 also includes a number of beacon devices 130A-D. The beacon devices 130A-D can transmit positioning signals from precise locations. The positioning signals can enable a mobile devices 120 to determine its own location. The beacon devices 130A-D may be used to create a positioning system that is sufficiently precise for some applications (e.g., construction, architecture, design, and facility management), as other device-locating technologies (e.g., GPS) may be insufficiently precise.

Position-determining algorithms may utilize the coordinates of the beacon devices 130A-D. Accordingly, the locations of the beacon devices 130A-D may be precisely determined (e.g., via the surveying equipment 112) to obtain real-world coordinates associated with each of the beacon devices 130A.

The beacon devices 130A-D can be used as an anchor point for augmented reality visualization of future physical elements. For example, beacon devices 130A-D may enable determining mobile device positions up to, for example, ⅛^{th} inch accuracy, ¼ inch accuracy, 1 inch accuracy, 2 inch accuracy, 6 inch accuracy, 1 foot accuracy, or any other suitable accuracy. Having a precise mobile device position can enable the mobile device to display an accurate augmented reality image of a future physical element, such that the augmented reality image is also sufficiently precise for construction applications (e.g., the augmented reality image of the future physical element is displayed within ⅛^{th} inch, ¼ inch, 1 inch, 2 inches, 6 inches, or 1 foot of its intended future position).

As a result, a worker may be able to use the augmented reality image alone as precise instructions for working in a project site 105. Without the beacon devices 130A-D (e.g., along with data acquisition devices 110), this level of precision may not be attainable, and the worker may then need to perform inconvenient manual measurements when working on a future physical element or other feature in a project site 105.

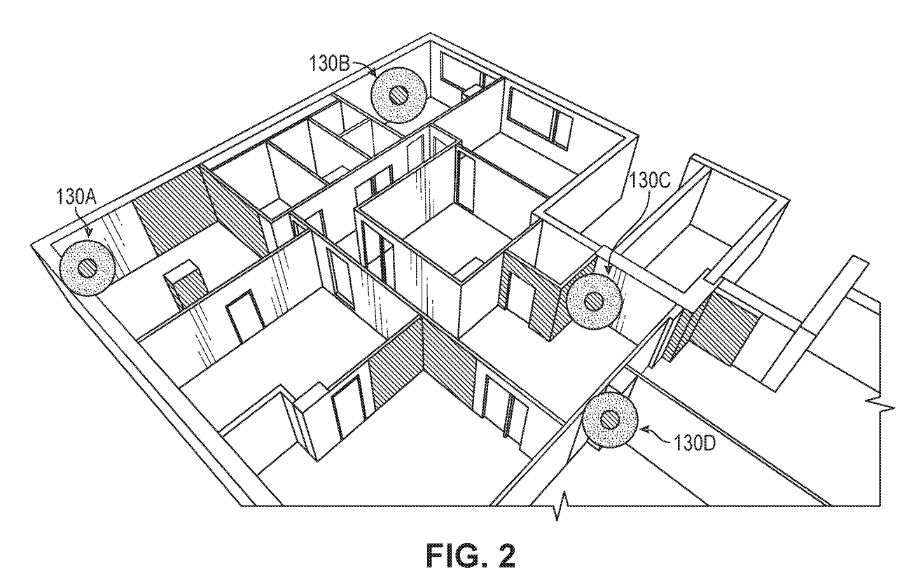

As shown in FIG. 2, the beacon devices 130A-D may be placed in various locations within and around the project site 105. In some embodiments, beacon devices 130A-D may be placed around the perimeter of the project site 105. For example, there may be at least four beacon devices 130A-D, such that there can be one beacon device 130 in each corner of the project site 105. In some embodiments, the beacon devices 130A-D can be distributed such that a mobile device 120 can receive signals from three or more beacon devices 130A-D (and thereby triangulate the mobile device position) at any location in the project site 105.

In some embodiments, the coordinates of the beacon devices 130A-D may be determined after they have been placed in the project site 105. For example, targets may be placed on the beacon devices 130A-D, such that the real-world coordinates of the targets (and thus the beacon devices 130A-D) may be measured with the data acquisition devices 110. Measurement of the coordinates of the beacon devices 130A-D can happen at the same time or different time as the 3D scans and surveying of the project site 105 (e.g., the physical elements 107A-C).

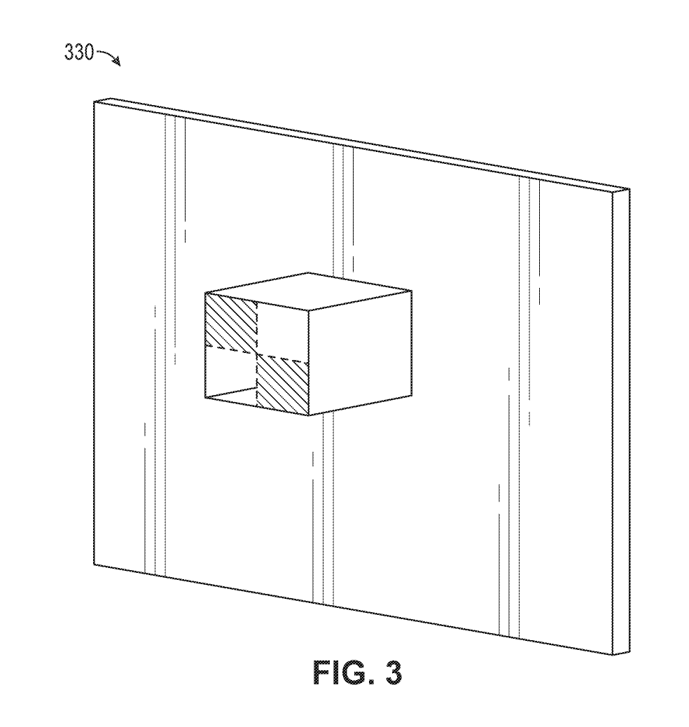

In some embodiments, as shown in FIG. 3, the beacon devices 130A-D can include targets, such as a target image shown on the face of a beacon device 330. Accordingly, the real-world coordinates of the beacon devices 130A-D can be directly surveyed from the face of the beacon devices 130A-D, and separate target instruments may not be needed.

In other embodiments, the beacon devices 130A-D can be placed at locations that have already been surveyed. Then, each beacon devices 130 can be associated with the already-surveyed coordinates.

In some embodiments, a beacon device may be a relatively large object. For example, a beacon device may have length, width, and/or height dimensions on the order of several inches, a foot, several feet, or larger. As a result, it is possible that signal transmitting hardware (e.g., an antenna) within a beacon device may not be in the same exact location of the beacon device as the surveyed location. For example, if the signal transmitting hardware is located on the corner of the beacon device, but the coordinates of the center of a beacon device are surveyed, there may be a discrepancy of several inches between the measured coordinates and the actual origin of triangulation signals. Accordingly, in some embodiments, a specific portion of the beacon devices 130A-D may be intentionally surveyed. For example, in some embodiments, the coordinates may indicate a position of a signal transmitter within a beacon device. This may enable more precise triangulation (e.g., within ⅛^{th} of an inch, ¼ inch, 1 inch, 2 inches, 6 inch, 1 foot, or any other distance).

In some embodiments, any suitable type of beacon device can be used, and the beacon devices 130A-D may communicate with the mobile device 120A-B in any suitable manner. For example, the beacon devices 130A-D may communicate via audio transmissions, radio communications, Wi-Fi, Bluetooth, BLE, 3G, visible light communications, etc. Examples of beacon devices include the iBeacon, the Eddystone, the AltBeacon, and any other suitable type of beacon hardware.

In some embodiments, a positioning signal sent by a beacon device 130 may include information about the time when the signal was sent, information about the coordinates of the beacon device 130, a unique identifier for the beacon device 130, or any other suitable information. In some embodiments, internal clocks at the beacon devices 130A-D and/or mobile devices 120A-B may be synchronized. For example, each device may receive a same set of timing information from a GPS system.

The beacon devices 130A-D may be able to confirm their own locations or each other's indicated locations, in some embodiments. For example, the coordinates of a first beacon device 130A may be surveyed and then uploaded into a computer memory of the first beacon device 130A. The first beacon device 130A may then receive positioning signals from the other beacon devices 130B-D, and determine its own position based on the positioning signals. If the stored coordinates do not match the signal-based position, the first beacon device 130A may correct the stored coordinates (e.g., replace them with the signal-based position). Alternatively, this can indicate that one of the other beacon devices 130B-D is not calibrated correctly, so the coordinates of another beacon device can be corrected (e.g., by re-surveying).

Referring to FIG. 1, the system 100 also includes a modeling computer 140. The modeling computer 140 can include a project database 146, a 3D modeling module 142, an augmented reality (“AR”) module 144, and any other suitable software module. While the 3D modeling module 142 and the AR module 144 are illustrated as separate modules, they can be integrated into a single module. In addition, there are a number of other components (e.g., data processor, memory, input/output module, or the like) in the modeling computer 140 which are not illustrated in FIG. 1.

The 3D modeling module 142 can include computer-aided design software, such as AutoCAD™, which can be used to generate a 3D digital model (e.g., 3D solids) of the project site 105. A 3D digital model refers to a three dimensional representation of an element or object in a digital format which can be viewed on a computer screen or other electronic devices. In one embodiment, the point clouds obtained from a 3D laser scanner can be imported into the 3D digital modeling module 142 and processed by a data processor to be traced over when constructing a 3D digital model.

A 3D digital model in accordance with the present invention may be an intelligent model—it may contain georeferenced real-world coordinates (e.g., coordinate data) for any point on the 3D digital model. In other words, any location on or around the 3D digital model can be clicked and selected in the 3D modeling module 142 to obtain real-world coordinates associated with the location. The 3D digital model of the project site 105 can be stored in the project database 146 of the modeling computer 140, uploaded to a third party AR software server (not shown in FIG. 1), and/or transmitted to one or more mobile devices 120A-B for storage.

The 3D modeling module 142 may also be used to generate a future physical element. For example, a future physical element may be a new physical element that does not yet exist, and that will be newly created and installed in the real environment by a skilled worker. A user may scan an existing physical element or prototype, or manually design a 3D digital model of a future physical element.

In some embodiments, a future physical element can be digitally placed at a specific and precise location within a 3D digital model of the project site 105. For example, the 3D digital model of the project site 105 may include real-world coordinates (e.g., up to ⅛^{th} inch accuracy), for each point, and the future physical element may be placed at an equally precise location within the 3D digital model of the project site 105, such that the future physical element is also associated with real-world coordinates. In some embodiments, this element-placing functionality can be performed by the AR module 144.

The AR module 144 can be a software application that can run on a number of different platforms. While the AR module 144 is shown as part of the modeling computer 140, it can be included in a mobile device 120, and its functions can be performed entirely or partly with the mobile device 120 depending on the memory and the processing power of the mobile device 120. In some embodiments, any suitable commercially available augmented reality software can be modified and applied. For example, AR software from Metaio™, Augment™, or any other suitable AR software applications can be modified and customized for augmented reality visualization according to embodiments of the present invention.

The AR module 144 can also be used to place a 3D digital model of a future physical element at a precise location associated with real-world coordinates, as described above. As a result, the 3D digital model of the future physical element can be displayed as a virtual object overlaid in the real environment by a mobile device. The virtual object can be overlaid in the real environment in a precise location based on the future physical element's real-world coordinates.

The project database 146 can store information about 3D digital models and other suitable project information. For example, the project database 146 can include survey measurements, 3D scan data, 3D digital models of the project site 105, 3D digital models of future physical elements and associated location data, and/or any other suitable information. In some embodiments, the project database 146 may include one or more specific project files (e.g., project data 148A-C). Project data 148A-C may include 3D digital models of future physical elements, real-world coordinates for the future physical elements, real-world coordinates for beacon devices 130A-B, and any other suitable information.

In some embodiments, different projects may have different project types. For example, each project data 148A-C may be associated with the same project site 105, but first project data 148A may be associated with a plumbing project, second project data 148B may be associated with an electrical project, and third project data 148C may be associated with a construction project. It is beneficial to limit the project information provided to each person (e.g., worker or other device user), such that only the relevant project information is viewed. For example, a plumber may only need to view plumbing project information, and other irrelevant project information could clutter the display or confuse the plumber. Projects can be divided among any other suitable type of profession. For example, projects can be categorized for plumbers, electricians, construction workers, welders, managers and supervisors, maintenance workers, a painters, landscapers, etc.

Accordingly, in some embodiments different projects may be assigned to certain categories and/or devices. For example, first project data 148A may be associated with a plumbing category, second project data 148B may be associated with an electrical category, and third project data 148C may be associated with a construction category. Each category may include multiple projects (e.g., there may be five plumbing projects). Further, in some embodiments, mobile devices 120A-B, and/or people can similarly be categorized. For example, mobile device 120A may be associated with the plumbing category, and mobile device 120B may be associated with the electrical category. As a result, mobile device 120A may receive the first project data 148A, while mobile device 120B may receive the second project data 148B.

Embodiments allow projects, people, and/or devices to be categorized and divided in any other suitable manner. For example, a supervisor may receive different project data than a laborer. A mobile device may be personalized for a specific user and receive project data relevant to that person. In some embodiments, mobile devices may be provided to workers, and the mobile devices may be marked or colored according to their category (e.g., different categories can have different colors).

In some embodiments, a project data file may further include supplemental content associated with a 3D digital model of a future physical element. Examples of supplemental content may include additional building information model (“BIM”) about the future physical element. For instance, the supplemental content may include an identification of future physical element (e.g., a description that it is a drainage pipe, a water pipe, an electrical conduit, or the like), information about construction materials used for the future physical element, manufacture information associated the future physical element, dimensions of the future physical element, RFI (request for information) numbers, or the like. In another embodiment, the supplemental content may include a maintenance schedule related to the future physical element.

The supplemental content may further include a recommended viewing angle or best distance for viewing an augmented reality image with a mobile device 120 on the project site 105. The supplemental content may be animated, auditory, visual, or a combination thereof, and different information layers of supplemental content can be selected by the user on a touch screen display of the mobile device 120 for visualization.

In some embodiments, the project data 148A-C files may further include instructions regarding when a data file can be retrieved and the 3D digital model of the future physical element displayed in an augmented reality image.

For example, in some embodiments, a project data file for a future physical element may be retrievable from the project database 146 by a mobile device 120 for augmented reality visualization if the mobile device 120 is associated with the same project category as the future physical element, and if the mobile device 120 is within a predetermined distance of the future physical element's location. A predetermined distance may be any suitable distance, such as 1 foot, 5 feet, 20 feet, 50 feet, 100 feet, 200 feet, or 1,000 feet. In other embodiments, a future physical element may always be shown, regardless of distance.

In some embodiments, instead of depending on the distance between the mobile device 120 and the future physical element location, the future physical element may appear in an augmented reality image when the mobile device 120 is in a certain room, on a certain floor, or in any other space from which it may be suitable to view a 3D digital model of the future physical element. For example, it may be helpful to a user if a model of a future heating element is shown whenever the user is in a location from which the actual heating element will be visible (e.g., there are no walls between the user and the future heating element location).

As another example, it may be helpful to a user if model of a future internal (e.g., inside a wall) water pipe is shown whenever the user is in a room adjacent to the wall that conceals the water pipe (e.g., from both rooms that share the wall).

In some embodiments, the future physical element may be dimensionally too large or long (e.g., continuous underground pipes) to be visualized at once on a mobile device display screen from a reasonable distance. Accordingly, a portion of the 3D digital model of the future physical element can be included in an augmented reality visualization depending on the mobile device position. For example, different portions of the 3D digital model of the future physical element can be associated with different regions (e.g., a different room or other area), so that when the mobile device is in a certain location, a corresponding portion of the 3D digital model of the future physical element can be shown on a display screen for augmented reality visualization. In some embodiments, different portions of a future physical element can be associated with a different category, such that different mobile devices and users can see different portions of the future physical element.

In further embodiments, the future physical element may be shown first, and the associated supplemental material may be shown second. For example, a future fire hydrant may become visible in an augmented reality image when a user's mobile device is within a first predetermined distance (e.g., 50 feet) of the future fire hydrant, and then the supplemental information may be shown when the user's mobile device is within a second predetermined distance (e.g., 10 feet) of the future fire hydrant. As a result, the user may be able to see a future physical elements from afar, and then the user can come closer to the future physical element in order to see supplemental information, if desired. This way, supplemental information for other more distant future physical elements may be hidden so that it does not clutter the display screen.

Referring to FIG. 1, the system 100 also includes the mobile devices 120A-B, which can be used to determine the viewer's position in the real environment and to view an augmented reality image. There may be any suitable number of mobile devices on the project site 105, as one or more workers may have their own mobile devices. Also, as explained above, each mobile device 120 may be associated with one or more project categories. Examples of the mobile devices 120A-B include any handheld computing device, such as a smartphone, a tablet computer, a gaming device, or a wearable device, such as glasses, or a combination thereof.

The mobile devices 120A-B may have a number of components, including a camera which can be used to detect and capture an image of an area within or near the project site 105 (e.g., an image of one of the physical elements 107A-C). Any real scenes seen through the camera and/or any images retrieved from a mobile device data storage (or retrieved from the modeling computer 140 or a third party AR server) can be processed by a data processor and displayed on a display screen of the mobile devices 120A-B. The mobile devices 120A-B can include input devices such as buttons, keys, or a touch screen display which can receive user input.

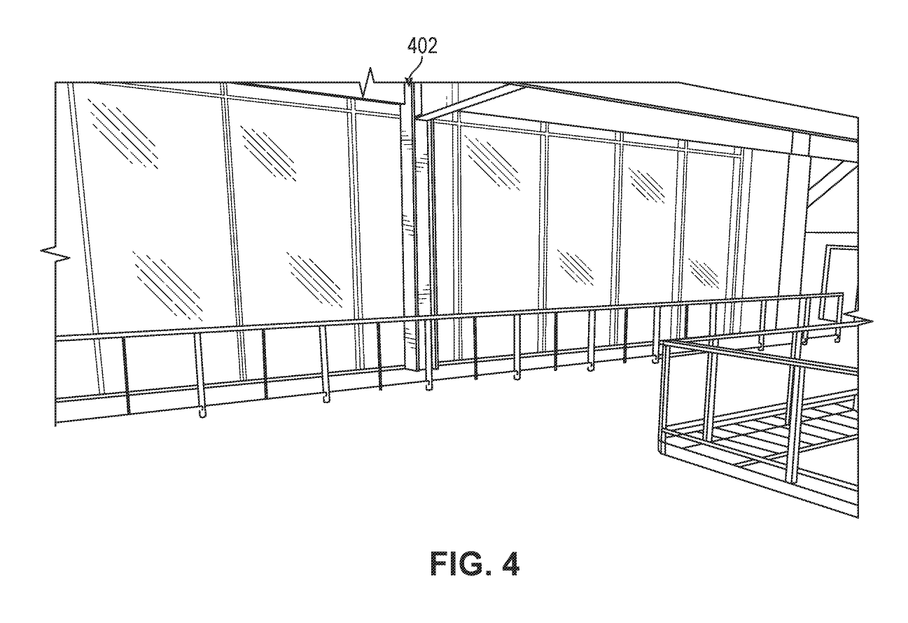

The mobile devices 120A-B may also include an AR application which can initiate and facilitate AR processing so that a user can visualize 3D augmented reality scenes on a display screen. An example of an augmented reality scene that can be displayed by the mobile devices 120A-B is shown in FIG. 4, where a 3D digital model of a beam 402 (an example of a future physical element) is overlaid on a real-time image of a real environment in a precise location.

In addition, the mobile devices 120A-B can include one or more sensors, such as a sensors for receiving signals from beacon devices 130A-D (e.g., acoustic sensors, light detectors, Wi-Fi, Bluetooth, cellular antennas, etc.), a GPS device, a gyroscope, a compass, an accelerometer, a barometer, and/or any other suitable sensor. The mobile devices 120A-B may include a positioning application which can determine the mobile device position in terms of real-world coordinates. The positioning application may also be able to determine the orientation of the mobile device (e.g., the direction that a camera on the mobile device is facing).

The mobile device 120A may determine the mobile device position based on communications with the beacon devices 130A-D. Several techniques exist for determining position based on signals from beacon devices 130A-D, such as triangulation, fingerprinting, etc. In some embodiments, the beacon devices 130A-D may function similarly to GPS satellites. The communication signals and positioning algorithms may be similar to those used in a GPS network. However, in contrast with a GPS network, the beacon devices 130A-D may only provide location services for a project site 105 and/or nearby areas. Also, because the beacon devices 130A-D are located closer than GPS satellites, the positioning network provided by the beacon devices 130A-D provides more precise positioning information. For example, the best GPS systems can reliably provide horizontal positioning within 13 feet of the actual location (and the vertical position is less accurate). In contrast, the local beacon devices 130A-D can provide a mobile device 120 position with construction-level accuracy (e.g., a determine position that is within ⅛^{th} inch of the actual position).

As specific examples, the mobile device 120A may determine the distance (or “range”) between the mobile device 120A and one or more beacon devices 130A-D based on comparing the signal arrival time with the initial transmission time (e.g., using time of flight calculations, or time difference of flight calculations), or by analyzing a received signal strength indicator (RSSI). In some embodiments, the mobile device 120A may have an internal clock that is synchronized with clocks at the beacon devices 130A-D. Accordingly, if the signals include information about when the signals were sent, the mobile device 120A can compare the times the signals were sent with the times the signals were received, and thereby determine the amount of time the signals were travelling over-the-air. Range measurements can be determined from the travel times. Then the range measurements and surveyed coordinates of the beacon devices 130A-D can be used to triangulate the position of the mobile device 120A. Embodiments allow the use of any other suitable method for determining the mobile device 120A position based on communications with the beacon devices 130A-D.

In some embodiments, the mobile devices 120A-B may receive the coordinates of the beacon devices 130A-D from the modeling computer 140. The coordinates may be provided together with or separately from with the project data. In other embodiments, the coordinates of the beacon devices 130A-D may be programmed into the beacon devices 130A-D themselves. Then, the beacon devices 130A-D may transmit their own coordinates as a part of the location signals. In either case, a mobile device 120 can obtain the coordinates of the beacon devices 130A-D, receive active signals from the beacon devices 130A-D, and then use the received information to determine its own position.

In one implementation, other sensors can be used in combination with the beacon device 130A-D signals in order to obtain a precise mobile device 120 location. For example, one or more sensors (e.g., gyroscope, accelerometer, and/or compass) can be used to track movements using inertial navigation, and update the current location of the mobile device 120. These sensors can also determine the orientation of the mobile device.

Further, the mobile device 120 can compare its current location to a 3D digital model of the project site 105 with real-world coordinates. As a result, the mobile device 120 can determine when future physical elements included in the 3D digital model are nearby.

The mobile device 120 can accurately determine the distance between a future physical element and the mobile device 120 position. The mobile device 120 can also determine whether or not a mobile device camera is facing the future physical element (e.g., based on the orientation of the mobile device 120 and the relative position of the future physical element). More specifically, the mobile device 120 can determine whether or not the current camera image is capturing the location associated with the future physical element. If the location of the future physical element is shown in the camera image, the mobile device 120 can overlay a virtual image of the future physical element, such that the future physical element is shown in its intended location in the project site 105.

Embodiments allow any suitable method to be used for determining whether or not the current camera image includes the intended location of the future physical element. In one example, the mobile device 120 may be configured to consider the field of view of the camera lens. The field of view describes how much physical space around the camera's direct line-of-sight is captured in an image. The area captured in a field of view can be mathematically described by a solid angle. In other words, the field of view defines how much of the real-world is captured in a single image. The field of view can be a property of the camera and/or display screen, and thus can vary across mobile devices. If the mobile device 120 is programmed to include information about the camera's field of view, and if the mobile device 120 can determine what direction it is facing (e.g., its orientation), the mobile device 120 can determine whether the location of the future physical element is captured in an image.

The mobile device 120 can overlay a virtual image of the future physical element onto a real-world image captured in real time. The mobile device 120 can display the future physical element accurately, so that it appears at the intended location, and so that it is sized and oriented correctly based on the position and direction from which the mobile device 120 is viewing.

Embodiments allow any suitable method to be used for displaying the future physical element in the correct location and with the correct size and orientation. In one example, the mobile device 120 can calculate how much screen-space should be used to display a future physical element. The mobile device 120 can perform this calculation using the mobile device 120 position, the mobile device 120 orientation, the mobile device camera's field of view, and the size of the future physical element. The mobile device 120 can determine what proportion of the field of view is occupied by the future physical element, and then display the future physical element with the same proportion on the display screen.

As a specific example, the future physical element may be located 5 meters away from the mobile device 120. The mobile device 120 can determine that the camera image captures, for a distance of 5 meters with a given field of view, a physical area of 70 square meters (e.g., a rectangular image of 7 horizontal meters by 10 vertical meters). The mobile device 120 identifies that the future physical element is rectangular heating unit that is 2 meters tall and 1 meter wide (and area of 2 square meters). Thus, the proportion of the size of the heating unit to the total space captured in the image (at a distance of 5 meters) is 2:70. In other words, the heating unit occupies 1/35^{th} of the total space. Accordingly, when the heating element is virtually overlaid onto the display screen's real-world image, the heating element should take up 1/35^{th} of the display screen. In this example, suppose the display screen is 20 cm tall and 14 cm wide, with a total area of 280 square cm. Thus, the entire 70 square meters of real-world space is compressed into a 280 square cm image. To display the heating element with the correct size and proportion, it should occupy 1/35^{th} of the 280 square cm image, or 8 square cm.

Similarly, the mobile device 120 can determine that 7 horizontal meters of real space are being shown on a screen of 14 horizontal cm, and that 10 vertical meters of real space are being shown on a screen of 20 vertical cm. Both dimensions are being reduced by a factor of 50 (e.g., 7 m/14 cm=50). Accordingly, the real-world dimensions of the future heating element should be similarly reduced for the virtual image, so that the screen-size of the heating element is 4 cm tall and 2 cm wide.

In some embodiments, the mobile device 120 can update the virtual image of a future physical element in real-time. As the mobile device 120 moves and the captured real-world image changes, the virtual overlaid future physical element can move on the display screen, such that it is always shown at the correct location with the correct size and orientation. For example, the displayed future physical element can increase in size as the mobile device 120 moves closer, as the future physical element occupies a greater proportion of the total field of view.

In some embodiments, the mobile device 120 may not have a camera. For example, the mobile device may be a pair of smart glasses that are capable of projecting a virtual image (e.g., in a “heads up display”). Thus, when the user looks through the glasses, the user can see both the virtual image and the real-world behind it (in total, an augmented reality image). In this case, the mobile device 120 may still consider a field of view, as described above. However, instead of a camera's field of view, it may be the user's own field of view and the size of the display screen on the smart glasses.

As explained above, in addition to the beacon devices 130A-D, other mobile device 120 sensors such as a gyroscope and accelerometer can be used to track changes in the elevation and distance between a future physical element location and the mobile device 120. For example, a gyroscope can determine if the mobile device 120 is being tilted. If tilted, the mobile device 120 can rotate, scale, and skew the virtual image of the future physical element to match the real-world perspective captured by the camera. Matrix transformation techniques can be used to rotate, scale, and skew the virtual image of the future physical element. Other variations, modifications, and alternatives can be used to adjust the future physical element (and 3D digital model) to appropriate perspectives based on the device position, orientation, field of view, screen shape, and any other suitable variables.

In other embodiments, the mobile device 120 may be able to precisely identify the coordinates of any point viewable in an image captured by the mobile device camera. For example, the mobile device 120 may be able to precisely determine the direction which the camera is facing, as well as the distance of any point in a captured image, and thus be able to determine coordinates of such points relative to the mobile device 120 position. Range and direction measurements may be precisely determined with internal gyroscopes, compasses, accelerometers, range measurement tools, GPS systems, etc.

Having determined the shapes and point coordinates in the real-world image, the mobile device 120 can identify a portion of the 3D digital model of the project site 105 that matches the real-world image. As a result, the mobile device 120 can determine which part of the project site 105 is being viewed. Then, the mobile device 120 can combine the real-world image with a virtual image of the 3D digital model of the project site 105, thereby creating the augmented reality image. The mobile device 120 may only include the portion of the 3D digital model that overlaps with the real-world image, and from the total 3D digital model of the project site 105, the mobile device 120 may only include a future physical element. Since each point of the 3D digital model of the future physical element is associated with specific coordinates, the virtual future physical element will be automatically sized and oriented correctly for the augmented reality image (e.g., based on the camera's position and viewing angle).

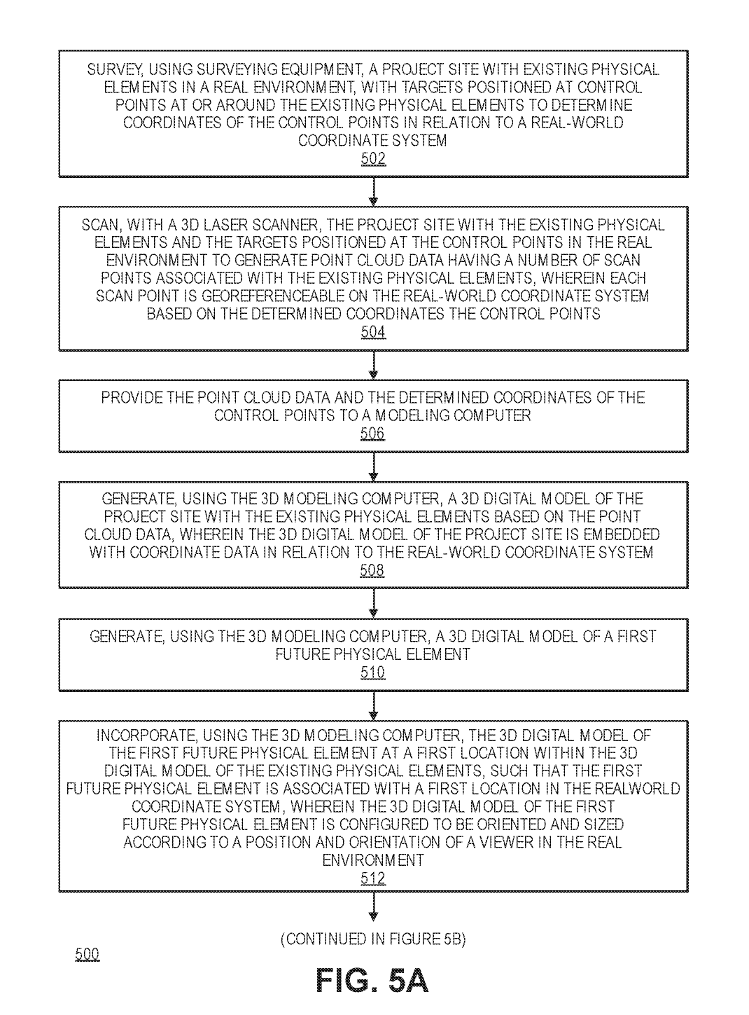

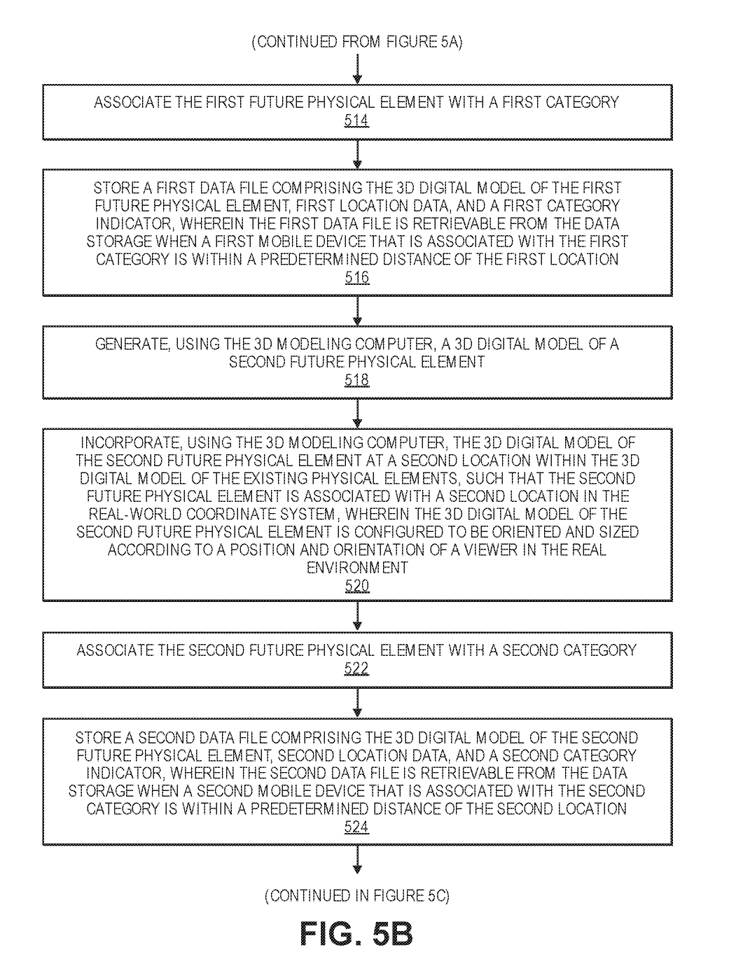

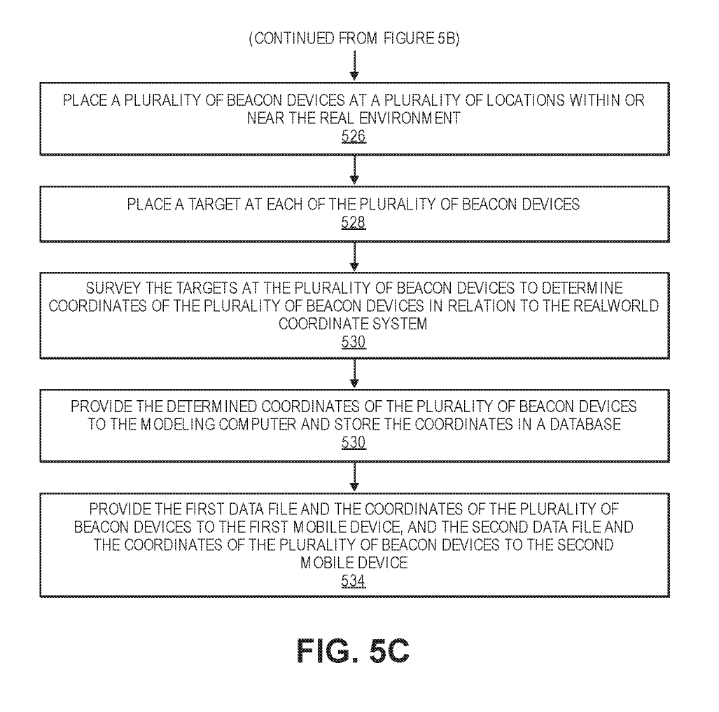

A method 500 according to embodiments of the invention can be described with respect to FIGS. 5A-5C.

In step 502, the surveying equipment 112 can be used to survey a project site 105 with physical elements 107A-C that already exist in a real environment (e.g., a room in a building). During the surveying process, targets can be placed on control points 118A-B on or around the project site 105, and the coordinates of the control points 118A-B can be determined in relation to a real-world coordinate system. For example, each control point can be defined in terms of “Northing, Easting, Elevation” based on a selected real-world coordinate system. Any suitable number of control points in any suitable locations can be used.

In step 504, the project site 105 with the physical elements 107A-C in the real environment can be scanned using the 3D laser scanner 114. The scan can obtain point cloud data associated with the project site 105. The point cloud data outlines contours of the project site 105 and provides information related to various geometric parameters associated with the project site 105. These can include dimensions and angles of various portions of the physical elements 107A-C in relation to one another. Thus, the shapes and features in the project site 105 can be determined, and the each point can be precisely defined.

The targets positioned on the control points 118A-B in step 502 can be also included in the scan. As a result, some of the scanned points can be associated with surveyed location information. This means that information about surveyed real-world coordinates can be embedded within the point cloud data. As described below, the location of point can be redefined with respect to the real-world coordinates.

In step 506, the point cloud data associated with the project site 105 can be provided to the modeling computer 140 via any suitable communication medium. The surveyed coordinates of the control points 118A-B can also be provided to the modeling computer 140.

In step 508, using the point cloud data, the 3D modeling module 142 in the modeling computer 140 can generate a 3D digital model of the project site 105. This 3D digital model can be visualized on a screen of a computer or other electronic devices. As a result, the dimensionally correct physical elements 107A-C can be viewed from any perspective within the virtual 3D environment. In an embodiment, the 3D digital model of the project site 105 may only include certain features, such as structural elements, while others include all mechanical, electrical, and plumbing elements modeled in their correct location, orientation, and scales. In another embodiment, different features of the project site 105 can be color-coded according to desired specifications.

Since the 3D digital model of the project site 105 is produced using accurately surveyed and scanned geometric and coordinate data, the geometric and coordinate data (e.g., dimensions, angles, coordinates, or the like) of the digital model displayed on a computer screen can be within ⅛^{th} of an inch of actual, real-life parameters of the project site 105. For example, there may be at least a 95 percent confidence level that each point and shape is shown within ⅛^{th} of an inch of the real-life features.

Each point in the 3D digital model may be assigned a set of coordinates based on the point cloud data. Initially, each point can be assigned coordinates that describe the distance (e.g., horizontal, vertical, and longitudinal displacement) of the point from some origin, such as the center of the project site 105 or the position of the 3D laser scanner 114. However, these coordinates can be redefined.

For example, the real-world coordinates of the surveyed control points 118A-B can be assigned to their corresponding points in the 3D digital model. Then, the real-world coordinates of the surveyed control points 118A-B can be used to redefine the coordinates of all other points in the 3D digital model (e.g., based on the relative location of each point to one or more controls points). This can provide real-world coordinates (e.g., Northing, Easting, and Elevation) to each point in the 3D digital model. As a result, the entire 3D digital model can be virtually placed within the real-world.

Since each point in the 3D digital model of the project site 105 can be assigned coordinates in a real-world coordinate system, a user may be able to identify the coordinates of any position in the 3D digital model. For example, any point on the surface of the 3D digital model of the project site 105 can be clicked and selected by the user to obtain real-world coordinates of the selected point.

In step 510, a 3D digital model of a first future physical element can be generated. For example, a user can design a new physical element, such as a pipe, a wall, or a beam, that may be added to (or otherwise incorporated into) the project site 105 in the future. The future physical element may be generated using the 3D modeling module 142 in the modeling computer 140. In some embodiments, the user can manually design the future physical element via computer-aided design software (e.g., AutoCAD™). In other embodiments, the user may obtain a 3D scan of an existing object or import a data file associated with a physical element.

In step 512, the 3D digital model of the first future physical element can be added to the 3D digital model of the project site 105. For example, the 3D digital model of the first future physical element can be placed at a specific location within the 3D digital model of the project site 105. As a result, the 3D digital model of the first future physical element can become tied in with the 3D model of the project site 105 in terms of their positions so that they co-exist in the same real-world coordinate system, and so that they can be displayed together by the 3D modeling module 142.

Upon tying the future physical element and project site 105 together, the relative location and orientation of the future physical element with respect to the project site 105 can be determined. Accordingly, specific coordinates in the real-world coordinate system can be assigned to the 3D digital model of the first future physical element. The coordinates can allow the first future physical element to be virtually added to an augmented reality image with the correct position, size, and orientation by a viewing mobile device (e.g., based on the position and orientation of the mobile device in the real environment).

In step 514, the first future physical element can be associated with a first category. For example, the first future physical element may be an element related to a certain trade, such as construction or plumbing, and it accordingly may be assigned to a category associated with the trade, such as a construction category or a plumbing category. As a result, a user or mobile device associated with the same category may be able to view the 3D model of the first future physical element during an augmented reality process. In some embodiments, step 514 can be performed by the AR module 144 after the 3D digital model of the first future physical element is imported into the AR module 144.

In step 516, a first data file may be stored that includes the 3D digital model of the first future physical element, location data such as real-world coordinates associated with the first future physical element, information about the first category such as a first category indicator, and any other suitable information. In some embodiments, the first data file may further include supplemental content associated with a future physical element (e.g., a type of element, construction materials needed, element dimensions, etc.).

In some embodiments, the first data file can be stored in the project database 146 of the modeling computer 140 and/or stored in a third party site (e.g., an AR software server). For example, the first data file may be labeled as first project data 148A in the project database 146. The first data file may also be transmitted to one or more mobile devices 120A-B for local storage. Storing the data on the mobile device 120 may be useful in some situations because accessing the modeling computer 140 or a third party server may require a Wi-Fi or cellular signal which can be difficult at remote plant locations or inside large buildings.

In some embodiments, the first data file may further include instructions regarding when the data file can be retrieved and the 3D digital model of the first future physical element displayed in an augmented reality image. For example, in some embodiments, the first data file may be retrieved if the mobile device 120 is within a predetermined distance of the first future physical element's location. Alternatively, such parameters may instead be specified at an augmented reality application on the mobile devices 120A-B.

Embodiments allow any suitable number of future physical elements to be modeled and associated with the same project site 105. Different project data files 148A-C can be created for different future physical elements. Accordingly, steps 510-516 can be repeated for a second future physical element.

In step 518, a 3D digital model of a second future physical element can be generated. In step 520, the 3D digital model of the second future physical element can be added to the 3D digital model of the project site 105. In step 522, the second future physical element can be associated with a second category. In step 524, a second data file may be stored that includes the 3D digital model of the second future physical element, location data such as real-world coordinates associated with the second future physical element, information about the second category such as a second category indicator, and any other suitable information.

In step 526, one or more beacon devices 130A-D may be placed at one or more locations within or near the project site 105. In some embodiments, the beacon devices 130A-D may be placed at predetermined locations and/or in a predetermined arrangement. In some embodiments, the beacon devices 130A-D may be distributed such that each area of the project site 105 can receive transmissions from three or more beacon devices 130A-D.

In step 528, targets may be placed on the beacon devices 130A-D, such that the real-world coordinates of the targets (and thus the beacon devices 130A-D) may be measured with the data acquisition devices 110. In some embodiments, instead of placing targets, the beacon devices 130A-D can already include targets, as shown in FIG. 3. In some embodiments, the targets may be placed in a specific area on the beacon devices 130A-D. For example, the targets may be placed on an antenna or other signal transmitting hardware, such that surveyed coordinates may be associated with the exact origin of any transmitted signals.

In step 530, the targets at the beacon devices 130A-D may be surveyed to determine coordinates of the beacon devices 130A-D in relation to the real-world coordinate system. In some embodiments, the beacon devices 130A-D may instead be placed at locations with real-world coordinates that have already been surveyed.

In some embodiments, steps 526-530 may take place during or immediately after steps 502-504 such that all surveying and on-site measuring activities can all be completed as one set of tasks.

In step 532, the surveyed coordinates of the beacon devices 130A-D can be provided to the modeling computer 140 via any suitable communication medium. The coordinates of the beacon devices 130A-D may also be stored in a database, such as the project database 146. In some embodiments, any other suitable beacon device information may also be provided and stored, such as information about specific signals or beacon device identifiers associated with different beacon devices 130A-D. In some embodiments, the coordinates of the beacon devices 130A-D may be provided to any other suitable entity, such as a separate computer for determining mobile device positions, or to the mobile devices. Additionally, in some embodiments, the surveyed coordinates of a beacon device may be loaded onto a memory of that beacon device.

In step 534, the first data file and/or information about the beacon devices 130A-D (e.g., coordinates and/or beacon device identifiers) may be provided to a mobile device that is also associated with the first category, such as a first mobile device 120A. Further, the second data file and/or information about the beacon devices 130A-D (e.g., coordinates and/or beacon device identifiers) may be provided to a mobile device that is also associated with the second category, such as a second mobile device 120B.

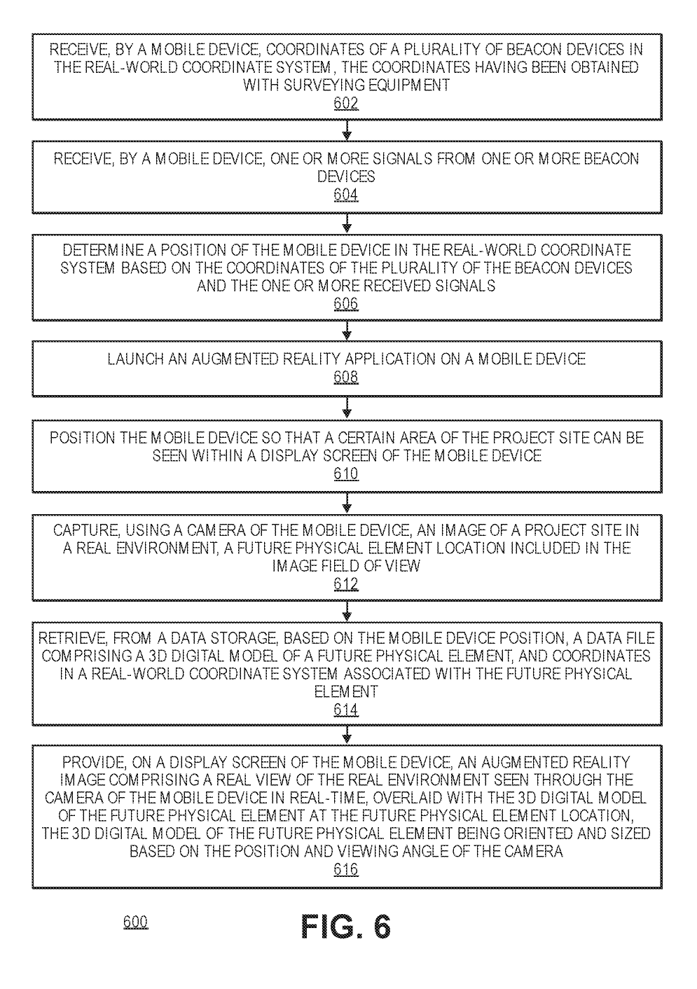

As explained below in FIG. 6, the mobile devices 120A-B may be able to determine their own coordinates based on signals from the beacon devices 130A-D. Then, based on the received data files, the determined mobile device coordinates, a mobile device orientation, and a mobile device camera field of view, the mobile device 120A-B may be able to display an augmented reality image including the 3D models of the future physical elements at their correct coordinates.

In some embodiments, the first data file and/or the coordinates of the beacon devices 130A-D may not be provided to the mobile device. For example, in some embodiments, mobile device position determination and/or augmented reality image generation may not happen at the mobile device level, and instead may take place at a server computer. Accordingly, the mobile device may not need to receive and/or store the first data file and/or the coordinates of the beacon devices 130A-D.

It should be appreciated that the specific steps illustrated in FIGS. 5A-C provide a particular method of surveying, laser scanning, 3D modeling, and associating a 3D digital model of a future physical element with real-world coordinates according to an embodiment of the present invention. Other sequences of steps may also be performed according to alternative embodiments. Alternative embodiments of the present invention may perform the steps outlined above in a different order. Moreover, the individual steps illustrated in FIGS. 5A-C may include multiple sub-steps that may be performed in various sequences as appropriate to the individual step. Furthermore, additional steps may be added or removed depending on the particular applications. One of ordinary skill in the art would recognize many variations, modifications, and alternatives.

FIG. 6 shows a flowchart illustrating a method 600 of using a mobile device running an augmented reality application to view an augmented image comprising a real view of a project site in real-time overlaid with a 3D digital model according to an embodiment of the present invention.

In step 602, a mobile device 120A may receive coordinates in the real-world coordinate system associated with one or more beacon devices 130A-D from the modeling computer 140. As described above, the coordinates of the beacon devices 130A-D may have been precisely measured using surveying equipment 112.

In step 604, the mobile device 120A may receive one or more positioning signals from one or more beacon devices 130A-D. The signals may include a time when the signals were emitted, a beacon device identifier, a certain signal strength, and/or any other suitable information or properties. In some embodiments, the coordinates associated with a beacon device 130 may be provided via positioning signals sent by that beacon device 130.

In step 606, the position of the mobile device 120A may be determined (e.g., by the mobile device 120A or the modeling computer 140). For example, the mobile device 120A may be able to determine its own position based on the coordinates of the beacon devices 130A-D and signals received from the beacon devices 130A-D. In some embodiments, the determined mobile device 120A position can be very precise (e.g., within ⅛^{th} of an inch). Additionally, the orientation of the mobile device 120A can also be determined (e.g., using a gyroscope, accelerometer, etc.).

In some embodiments, the mobile device 120A position may be continually tracked as the user moves about the project site 105. In other embodiments, the mobile device 120A position may only be determined when the user activates an augmented reality application on the mobile device 120A. Accordingly, steps 602-606 can happen after any of steps 608-612.

In step 608, a user may launch an augmented reality application on a mobile device 120A. The user may wish to view a future physical element that is associated with a nearby location. In some embodiments, the mobile device 120A may vibrate, emit a sound, or perform other functions to inform the user that a future physical element is nearby and can be viewed.

In step 610, the user can position the mobile device 120 so that a certain area of the project site 105 and/or a specific physical element 107 can be seen within the display screen of the mobile device 120A. For example, the user may know about plans for constructing future physical element in a certain area, or there may be a marker or other indicator that a future physical element can be seen if a mobile device camera is aimed in a certain direction.

In step 612, using the camera of the mobile device 120A, an image of the project site 105 and/or a specific physical element 107 in the real environment can be captured. A location associated with a future physical element may be visible in the image. In some embodiments, a future physical element location may be in the image's field of view but not directly visible in the image, as it may be blocked by an existing physical element.

In step 614, a data file (e.g., first project data 148A) comprising a 3D digital model of a future physical element associated with nearby coordinates can be retrieved. The data file may also include supplemental information associated with the future physical element. The data file may be identified based on the mobile device 120A position and/or orientation. The data file may be obtained from the modeling computer 140, from local storage at the mobile device 120, or from a third party site. The data file may include accurate location coordinates in the real-world coordinate system associated with the future physical element.

As explained above, the data file may be retrieved when the mobile device 120A is within a predetermined distance of the future physical element coordinates, when the mobile device 120A is in a specific regions such as a certain room, when the mobile device 120A crosses a geo-fence, or when the mobile device 120A is otherwise in a suitable position for viewing a 3D digital model of the future physical element at the intended location of the future physical element. Additionally, in some embodiments, the data file may be retrieved if the coordinates associated with the future physical element are viewable in the image captured in step 612.

In step 616, the mobile device 120A may display an augmented reality image on a display screen. The augmented reality image may comprise a real view of the project site 105 (e.g., the real environment) seen through the camera overlaid with the virtual 3D digital model representing the future physical element. The virtual 3D digital model of the future physical element may be shown on the display screen such that it appears to be located at coordinates associated with the future physical element.

In some embodiments, the mobile device 120A may first display the future physical element when the mobile device 120A is within a first predetermined distance or within a first region. Then, as the user moves closer, the mobile device 120A may display the supplemental information associated with the future physical element (e.g., when the mobile device 120A is within a second predetermined distance or within a second region). Alternatively, the supplemental information may always be shown with the future physical element, or the user can toggle the supplemental information on and off.

The future physical element may be displayed with sufficient accuracy for industrial applications (e.g., it may be shown within ⅛^{th} of an inch of the actual coordinates). An equally accurate mobile device 120A position may necessary to achieve this accurate augmented reality image. As explained above, the use of local beacon devices 130A-D may provide a sufficiently accurate mobile device 120A position.

As explained above, the precise display of the virtual future physical element in the augmented reality image can be achieved using on the mobile device 120A position, the mobile device 120A orientation, the mobile device 120A camera field of view, the real-world coordinates associated with the future physical element, and/or any other suitable information. The mobile device 120A can use this information to translate the intended size, location, and orientation of the future physical element to a corresponding on-screen display.

Alternatively, as explained above, the mobile device 120A can match a real-world image to a 3D digital model of the project site 105. The mobile device 120A can then selectively display a portion of the total 3D digital model (e.g., the future physical element) over the real-world image.

Using the mobile device 120A, a user can walk around the project site 105 and view the augmented reality image from various angles and distances from the intended future physical element location. As the user walks around the project site 105 or tilts the mobile device 120A, the mobile device 120A position can be constantly tracked. As a result, the 3D digital image of the future physical element can be constantly shifted and scaled in the mobile device 120A display screen such that the future physical element is always shown in the correct place.

In some embodiments, one or more of the above functions can be performed by a server computer (e.g., the modeling computer 140) or another suitable device instead of the mobile device 120A. For example, the determination of the position of the mobile device 120A and/or the generation of the augmented reality image can take place at a server computer. In some embodiments, after receiving the one or more signals from the beacon devices 130A-D, the mobile device 120A may send information about the received signals to a server computer. The server computer can then determine the mobile device 120A position based on the received signals and the coordinates of the beacon devices 130A-D, and then return the determined position to the mobile device 120A.

Similarly, the server computer may be able to receive a real-time feed from the mobile device 120A camera, identify a relevant future physical element data file based on the mobile device 120A position, generate the augmented reality image based on the camera-feed, the mobile device 120A position, and the data file, and then transmit the augmented reality image back to the mobile device 120A for displaying. Accordingly, the mobile device 120A may not need to receive or store the coordinates of the beacon devices 130A-D or the data file in step 602, as this data can be stored elsewhere and the position determination and augmented reality image processing can take place elsewhere.

It should be appreciated that the specific steps illustrated in FIG. 6 provides a particular method of displaying a virtual 3D digital model within a real environment according to an embodiment of the present invention. Other sequences of steps may also be performed according to alternative embodiments. For example, alternative embodiments of the present invention may perform the steps outlined above in a different order. Moreover, the individual steps illustrated in FIG. 6 may include multiple sub-steps that may be performed in various sequences as appropriate to the individual step. Furthermore, additional steps may be added or removed depending on the particular applications. One of ordinary skill in the art would recognize many variations, modifications, and alternatives.

As described above, embodiments of the invention allow a 3D digital model of a future physical element to be displayed in precise real-world coordinates within an augmented reality image. However, embodiments are not limited to future physical elements. Some embodiments allow other information to be precisely displayed in an augmented reality image. For example, internal elements can also be digitally modeled and displayed in an augmented reality image. Internal elements include physical elements that are concealed inside walls and panels, such that they may not be scanned in a 3D scan of a project site. Example internal elements include pipes and electrical components. Internal elements might be scanned before covered, or otherwise modeled in a modeling module and associated with precise real-world coordinates. Accordingly, embodiments allow a user to view otherwise-concealed internal elements in an augmented reality image displayed by a mobile device.

Further, embodiments allow other construction-related projects to be precisely mapped and viewed in an augmented reality image, such as instructions and images for how an existing physical element should be modified, instructions and images about how certain physical elements should be removed, measurements associated with existing physical elements, and any other suitable information or elements that may not be immediately visible to the human eye.

Embodiments of the present invention provide several advantages. Augmented reality can be used as a tool to display virtual designs or 3D models in the context of the true, existing environment in real-time. This is particularly useful in the fields of architecture, design, facility management, and construction. For example, when designing a plant retrofit or upgrade, designers would have the capability of viewing the proposed changes at the job site as if the changes were already made, prior to beginning work or making final decisions. The design plans can be changed on-site when engineers and designers walk the project site, visualizing how various future physical elements might function and interconnect within the context of the entire facility. Thus, embodiments of the present invention can improve overall efficiency of a project in terms of time and cost, and provide a better way to preview civil engineering projects.

Additionally, embodiments of the invention provide precise determination of the mobile device position via a local network of beacon devices with surveyed positions. Accurate augmented reality images are improved by this precise knowledge of the viewer's position. Without a local network of beacon devices, mobile device position may only be determined within several feet (e.g., via GPS). In such a scenario, a mobile device augmented reality application may only be able to display a future physical element in a general area (with an uncertainty of several feet in the displayed position) and not in the exact intended location. This may be insufficiently precise for construction-related applications, as measurements and worker instructions may require more accurate location information. For example, some applications may require an accuracy within ⅛^{th} inch, ¼ inch, 1 inch, 2 inches, 6 inches, a foot, or any other suitable distance. Accordingly, incorporating a local network of beacons and obtaining precise coordinates of beacon devices and the project site through surveying and 3D laser scanning enables precise digital modeling and augmented reality applications that are suitable for construction environments. In some embodiments, these precise augmented reality applications can effectively replace manual measurements and printed blueprints (and other instructions), as workers can refer solely to the precise augmented reality models for instructions.

Embodiments of the invention further advantageously provide a set of construction projects that can be divided based on a project type (e.g., plumbing, electrical, etc.). Then, the different categories of projects can be loaded onto different subsets of mobile devices intended for different types of workers. This improves the distribution of information to workers, and removes clutter (e.g., unneeded project information) from each worker's augmented reality view.

Another embodiment of the invention is directed to a server computer comprising a processor and a computer readable medium, the computer readable comprising code, executable by a processor, for implementing a method comprising: surveying a real environment including existing physical elements, with one or more targets positioned at one or more control points in the real environment to determine coordinates of the one or more control points in relation to a real-world coordinate system; importing the coordinates of the one or more surveyed control points into a 3D modeling computer; generating, using the 3D modeling computer, a 3D digital model including the existing physical elements in relation to the real-world coordinate system; generating, using the 3D modeling computer, a 3D digital model including a future physical element; incorporating, using the 3D modeling computer, the 3D digital model including the future physical element at a location within or proximate the 3D digital model including the existing physical elements, such that the future physical element is associated with a future physical element location in the real-world coordinate system; storing a data file comprising the 3D digital model including the future physical element and future physical element location data; placing a plurality of beacon devices at a plurality of beacon device locations in the real environment; surveying the plurality of beacon devices, with a target positioned at each beacon device, to determine coordinates of the plurality of beacon devices in relation to the real-world coordinate system; and storing the coordinates of the plurality of beacon devices in a database, wherein a mobile device position of a mobile device is determined based on communications between the plurality of beacon devices and the mobile device, wherein, when the determined mobile device position is within a predetermined region associated with the future physical element, an augmented reality image based on the data file is displayed at the mobile device, the augmented reality image comprising a real view of the real environment seen through the camera of the mobile device in real-time overlaid with the 3D digital model including the future physical element at the future physical element location.

Another embodiment of the invention is directed to a mobile device comprising a processor and a computer readable medium, the computer readable comprising code, executable by a processor, for implementing a method comprising: receiving, by a mobile device, a plurality of signals from a plurality of beacon devices; determining a position of the mobile device in a real-world coordinate system based on the plurality of received signals; capturing, using a camera of the mobile device, an image of a real environment including one or more existing physical elements; and providing, on a display screen of the mobile device, an augmented reality image comprising a real view of the real environment seen through the camera of the mobile device in real-time overlaid with a 3D digital model including a future physical element at a future physical element location in the real-world coordinate system.

Another embodiment of the invention is directed to a server computer comprising a processor and a computer readable medium, the computer readable comprising code, executable by a processor, for implementing a method comprising: surveying a real environment including existing physical elements, with one or more targets positioned at one or more control points in the real environment to determine coordinates of the one or more control points in relation to a real-world coordinate system; importing the coordinates of the one or more surveyed control points into a 3D modeling computer; generating, using the 3D modeling computer, a 3D digital model including the existing physical elements in relation to the real-world coordinate system; generating, using the 3D modeling computer, a first 3D digital model including a first future physical element; incorporating, using the 3D modeling computer, the first 3D digital model including the first future physical element at a first location within or proximate the 3D digital model including the existing physical elements, such that the first future physical element is associated with a first future physical element location in the real-world coordinate system; associating the first future physical element with a first category; storing a first data file comprising the first 3D digital model including the first future physical element, first future physical element location data, and a first category indicator; generating, using the 3D modeling computer, a second 3D digital model including a second future physical element; incorporating, using the 3D modeling computer, the second 3D digital model including the second future physical element at a second location within or proximate the 3D digital model including the existing physical elements, such that the second future physical element is associated with a second future physical element location in the real-world coordinate system; associating the second future physical element with a second category; and storing a second data file comprising the second 3D digital model including the second future physical element, second future physical element location data, and a second category indicator, wherein a first mobile device position of a first mobile device associated with the first category is determined based on communications between a plurality of beacon devices and the first mobile device, wherein, when the determined first mobile device position is within a predetermined region associated with the first future physical element, an augmented reality image based on the first data file is displayed at the first mobile device, the augmented reality image comprising a real view of the real environment seen through the camera of the first mobile device in real-time overlaid with the first 3D digital model including the first future physical element at the first future physical element location, wherein a second mobile device position of a second mobile device associated with the second category is determined based on communications between the plurality of beacon devices and the second mobile device, and wherein, when the determined second mobile device position is within a predetermined region associated with the second future physical element, an augmented reality image based on the second data file is displayed at the second mobile device, the augmented reality image comprising a real view of the real environment seen through the camera of the second mobile device in real-time overlaid with the second 3D digital model including the second future physical element at the second future physical element location.

Another embodiment of the invention is directed to a system comprising a first mobile device, the first mobile device comprising a processor and a computer readable medium, the computer readable comprising code, executable by a processor, for implementing a method comprising: capturing, using a camera of a first mobile device, an image of a real environment including one or more existing physical elements, wherein the first mobile device is associated with a first category; retrieving, by the first mobile device, a first data file comprising a first 3D digital model including a first future physical element and first future physical element location data that identifies a first location in a real-world coordinate system, wherein the first data file is associated with the first category; and providing, on a display screen of the first mobile device, a first augmented reality image comprising a real view of the real environment seen through the camera of the first mobile device in real-time, overlaid with the first 3D digital model including the first future physical element at the first future physical element location; and a second mobile device, the second mobile device comprising a processor and a computer readable medium, the computer readable comprising code, executable by a processor, for implementing a method comprising: capturing, using a camera of a second mobile device, an image of the real environment including the one or more existing physical elements, wherein the second mobile device is associated with a second category; retrieving, by the second mobile device, a second data file comprising a second 3D digital model including a second future physical element and second future physical element location data that identifies a second location in the real-world coordinate system, wherein the second data file is associated with the second category; and providing, on a display screen of the second mobile device, a second augmented reality image comprising a real view of the real environment seen through the camera of the second mobile device in real-time, overlaid with the second 3D digital model including the second future physical element at the second future physical element location.

The following computer system may be used to implement any of the entities or components described above. A computer system's subsystems are interconnected via a system bus. Subsystems include a printer, a keyboard, a storage device, and a monitor, which is coupled to a display adapter. Peripherals and input/output (I/O) devices, which couple to an I/O controller, can be connected to the computer system by any number of means known in the art, such as a serial port. For example, an I/O port or external interface can be used to connect the computer apparatus to a wide area network such as the Internet, a mouse input device, or a scanner. The interconnection via system bus allows a central processor to communicate with each subsystem and to control the execution of instructions from a system memory or a storage device, as well as the exchange of information between subsystems. The system memory and/or the storage device may embody a computer-readable medium.

As described, the inventive service may involve implementing one or more functions, processes, operations or method steps. In some embodiments, the functions, processes, operations or method steps may be implemented as a result of the execution of a set of instructions or software code by a suitably-programmed computing device, microprocessor, data processor, or the like. The set of instructions or software code may be stored in a memory or other form of data storage element which is accessed by the computing device, microprocessor, etc. In other embodiments, the functions, processes, operations or method steps may be implemented by firmware or a dedicated processor, integrated circuit, etc.

Any of the software components or functions described in this application may be implemented as software code to be executed by a processor using any suitable computer language such as, for example, Java, C++ or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may reside on or within a single computational apparatus, and may be present on or within different computational apparatuses within a system or network.

While certain exemplary embodiments have been described in detail and shown in the accompanying drawings, it is to be understood that such embodiments are merely illustrative of and not intended to be restrictive of the broad invention, and that this invention is not to be limited to the specific arrangements and constructions shown and described, since various other modifications may occur to those with ordinary skill in the art.

As used herein, the use of “a”, “an” or “the” is intended to mean “at least one”, unless specifically indicated to the contrary.

1.-20. (canceled)

21. A method comprising:
surveying, with surveying equipment, a real environment including existing physical elements, with one or more targets positioned at one or more control points in the real environment to determine coordinates of the one or more control points in relation to a real-world coordinate system;
importing the coordinates of the one or more surveyed control points into a 3D modeling computer;
generating, using the 3D modeling computer, a 3D digital model including the existing physical elements in relation to the real-world coordinate system;
generating, using the 3D modeling computer, a 3D digital model including a future physical element;
incorporating, using the 3D modeling computer, the 3D digital model including the future physical element at a location within or proximate the 3D digital model including the existing physical elements, such that the future physical element is associated with a future physical element location in the real-world coordinate system;
storing a data file comprising the 3D digital model including the future physical element and future physical element location data;
placing a plurality of beacon devices at a plurality of beacon device locations in the real environment;
surveying, with the surveying equipment, the plurality of beacon devices, with a target positioned at each beacon device, to determine coordinates of the plurality of beacon devices in relation to the real-world coordinate system, the coordinates including Northing, Easting, and Elevation coordinates; and
storing the coordinates including Northing, Easting, and Elevation coordinates of the plurality of beacon devices in a database,
wherein a mobile device position of a mobile device is determined based on communications between the plurality of beacon devices and the mobile device,
wherein, when the determined mobile device position is within a predetermined region associated with the future physical element, an augmented reality image based on the data file is displayed at the mobile device, the augmented reality image comprising a real view of the real environment seen through a camera of the mobile device in real-time overlaid with the 3D digital model including the future physical element at the future physical element location.

22. The method of claim 21, further comprising:
providing the data file and the coordinates including the Northing, Easting, and Elevation coordinates of the plurality of beacon devices to the mobile device.

23. The method of claim 21, wherein the determined mobile device position has at least ⅛^{th} of an inch accuracy, and wherein the future physical element is displayed at the future physical element location in the augmented reality image with at least ⅛^{th} of an inch accuracy.

24. The method of claim 21, further comprising:
receiving, at the mobile device, a plurality of signals from the plurality of beacon devices;
determining a position of the mobile device in the real-world coordinate system based on the plurality of received signals and the coordinates of the plurality of beacon devices; and
providing, on a display screen of the mobile device, the augmented reality image comprising the real view of the real environment seen through the camera of the mobile device in real-time overlaid with the 3D digital model including the future physical element at the future physical element location.

25. The method of claim 21, wherein the future physical element is a first future physical element, wherein the mobile device is a first mobile device associated with a first category, wherein the data file is a first data file, and wherein the method further comprises:
associating the first future physical element with the first category, wherein the first data file further includes a first category indicator, and wherein the augmented reality image based on the first data file was displayed at the first mobile device because the first mobile device is associated with the first category;
generating, using the 3D modeling computer, the 3D digital model including a second future physical element;
incorporating, using the 3D modeling computer, the 3D digital model including the second future physical element at a second location within or proximate the 3D digital model including the existing physical elements, such that the second future physical element is associated with a second future physical element location in the real-world coordinate system;
associating the second future physical element with a second category; and
storing a second data file comprising the 3D digital model including the second future physical element and second future physical element location data,
wherein a second mobile device position of a second mobile device is determined based on communications between the plurality of beacon devices and the second mobile device, and
wherein, when the determined second mobile device position is within a predetermined region associated with the second future physical element, a second augmented reality image based on the second data file is displayed at the second mobile device, the second augmented reality image comprising a real view of the real environment seen through the camera of the second mobile device in real-time overlaid with the 3D digital model including the second future physical element at the second future physical element location.

26. The method of claim 21, comprising:
receiving, by the mobile device, a plurality of signals from the plurality of beacon devices;
determining a position of the mobile device in the real-world coordinate system based on the plurality of received signals;
capturing, using a camera of the mobile device, an image of the real environment including the existing physical elements; and
providing, on a display screen of the mobile device, the augmented reality image comprising the real view of the real environment seen through the camera of the mobile device in real-time overlaid with the 3D digital model including the future physical element at the future physical element location in the real-world coordinate system.

27. The method of claim 26, further comprising:
receiving the Northing, Easting, and Elevation coordinates associated with the plurality of beacon devices in the real-world coordinate system, the coordinates having been obtained with the surveying equipment,
wherein the position of the mobile device is determined further based on the received Northing, Easting, and Elevation coordinates of the plurality of the beacon devices.

28. The method of claim 26, further comprising:
retrieving, by the mobile device, the data file based on the determined mobile device position, the data file comprising the 3D digital model including the future physical element and future physical element location data.

29. The method of claim 26, wherein the determined mobile device position has at least ⅛^{th} of an inch accuracy, and wherein the future physical element is displayed at the future physical element location in the augmented reality image with at least ⅛^{th} of an inch accuracy.

30. The method of claim 26, wherein the mobile device position is determined using triangulation.

31. A method comprising:
surveying, using surveying equipment, a real environment including existing physical elements, with one or more targets positioned at one or more control points in the real environment to determine coordinates including Northing, Easting, and Elevation coordinates of the one or more control points in relation to a real-world coordinate system;
importing the coordinates of the one or more surveyed control points into a 3D modeling computer;
generating, using the 3D modeling computer, a 3D digital model including the existing physical elements in relation to the real-world coordinate system;
generating, using the 3D modeling computer, a first 3D digital model including a first future physical element;
incorporating, using the 3D modeling computer, the first 3D digital model including the first future physical element at a first location within or proximate the 3D digital model including the existing physical elements, such that the first future physical element is associated with a first future physical element location in the real-world coordinate system;
associating the first future physical element with a first category;
storing a first data file comprising the first 3D digital model including the first future physical element, first future physical element location data, and a first category indicator;
generating, using the 3D modeling computer, a second 3D digital model including a second future physical element;
incorporating, using the 3D modeling computer, the second 3D digital model including the second future physical element at a second location within or proximate the 3D digital model including the existing physical elements, such that the second future physical element is associated with a second future physical element location in the real-world coordinate system;
associating the second future physical element with a second category; and
storing a second data file comprising the second 3D digital model including the second future physical element, second future physical element location data, and a second category indicator,
wherein a first mobile device position of a first mobile device associated with the first category is determined based on communications between a plurality of beacon devices and the first mobile device,
wherein, when the determined first mobile device position is within a predetermined region associated with the first future physical element, an augmented reality image based on the first data file is displayed at the first mobile device, the augmented reality image comprising a real view of the real environment seen through a camera of the first mobile device in real-time overlaid with the first 3D digital model including the first future physical element at the first future physical element location,
wherein a second mobile device position of a second mobile device associated with the second category is determined based on communications between the plurality of beacon devices and the second mobile device, and
wherein, when the determined second mobile device position is within a predetermined region associated with the second future physical element, an augmented reality image based on the second data file is displayed at the second mobile device, the augmented reality image comprising a real view of the real environment seen through the camera of the second mobile device in real-time overlaid with the second 3D digital model including the second future physical element at the second future physical element location.

32. The method of claim 31, wherein the first category is associated with a first profession, and wherein the second category is associated with a second profession.

33. The method of claim 32, wherein the first profession is one of a plumber, an electrician, a construction worker, a welder, a manager, a maintenance worker, or a painter.

34. The method of claim 31, wherein the first category is associated with a first set of mobile devices, and wherein the second category is associated with a second set of mobile devices.

35. The method of claim 34, wherein each mobile device in the first set of mobile devices includes a first type of physical marking, and wherein each mobile device in the second set of mobile devices includes a second type of physical marking.

36. A system comprising:
a plurality of beacon devices at a plurality of beacon device locations in a real environment;
a data acquisition device comprising surveying equipment configured to survey the real environment including existing physical elements, with one or more targets positioned at one or more control points in the real environment to determine coordinates of the one or more control points in relation to a real-world coordinate system, and survey the plurality of beacon devices, with a target positioned at each beacon device, to determine coordinates of the plurality of beacon devices in relation to the real-world coordinate system, the coordinates being Northing, Easting, and Elevation coordinates; and
a 3D modeling computer comprising a processor, and a computer readable medium programmed to cause the processor to import the coordinates of the one or more surveyed control points, generate a 3D digital model including the existing physical elements in relation to the real-world coordinate system, generate a 3D digital model including a future physical element, incorporate the 3D digital model including the future physical element at a location within or proximate the 3D digital model including the existing physical elements, such that the future physical element is associated with a future physical element location in the real-world coordinate system, store a data file comprising the 3D digital model including the future physical element and future physical element location data, and store the coordinates including Northing, Easting, and Elevation coordinates of the plurality of beacon devices in a database; and
a mobile device, wherein a mobile device position of the mobile device is determined based on communications between the plurality of beacon devices and the mobile device, and wherein when the determined mobile device position is within a predetermined region associated with the future physical element, an augmented reality image based on the data file is displayed at the mobile device, the augmented reality image comprising a real view of the real environment seen through a camera of the mobile device in real-time overlaid with the 3D digital model including the future physical element at the future physical element location.

37. The system of claim 36, wherein the 3D modeling computer comprises a project database comprising different project data, which is respectively obtainable by different mobile devices.

38. The system of claim 36, further comprising the existing physical elements and control points in the real environment that are not specifically associated with the beacon devices.

39. The system of claim 36, wherein the real environment is a construction site.
